(19) United States
(12) Patent Application Publication
(10) Pub. No.: US 2025/0306528 A1
(43) Pub. Date: Oct. 2, 2025

(54) DEVELOPING APPARATUS AND CARTRIDGE

(71) Applicant: CANON KABUSHIKI KAISHA, Tokyo (JP)

(72) Inventors: Ryota Ooka, Shizuoka (JP); Naoki Matsumaru, Shizuoka (JP); Tomofumi Kawamura, Shizuoka (JP)

(21) Appl. No.: 19/090,856

(22) Filed: Mar. 26, 2025

(30) Foreign Application Priority Data
Mar. 29, 2024 (JP) 2024-057735

(51) Int. Cl. G03G 21/18; G03G 15/08

(52) U.S. Cl. CPC G03G 21/1814; G03G 15/0808; G03G 15/0812; G03G 15/0898; G03G 21/1832

(57) ABSTRACT

In a developing apparatus, a support member of a regulating member for regulating the thickness of a layer of developer has a recessed portion, on a side the same as a first end of a frame body, the recessed portion being recessed in an intersecting direction with respect to a rotation axis of a developing roller; the frame body has protruding portions including a first protruding portion and a second protruding portion, being aligned with respect to each other, with a gap therebetween, in the direction of the rotation axis, and protruding in the intersecting direction; and by an engagement between the protruding portion and the recessed portion, the support member is positioned with respect to the frame body; and the space in the first end and to be sealed by a sealing member communicates with outside of the frame body via the gap.

### BACKGROUND OF THE INVENTION

### Field of the Invention

The present invention relates to a developing apparatus provided to an image forming apparatus that forms an image on a recording medium, using developer.

### Description of the Related Art

In an image forming apparatus that forms an image using electrophotography, a developing apparatus is provided. The developing apparatus is for developing an electrostatic image borne on a photosensitive drum, which is an image bearing member, as a toner image (developer image). To a frame body included in such a developing apparatus, a developing blade unit is attached. The developing blade unit is a regulating member for regulating the amount of developer to be borne on a developing roller, which is a developer bearing member. The developing blade unit includes a blade member that is a sliding portion, and a blade support member that is a supporting portion. Japanese Patent Application Laid-open No. 2022-130369 discloses a configuration for positioning the developing blade unit in the longitudinal direction of the developing apparatus, by fitting a protruding portion of the frame body into a first cutout portion provided to the blade support member. Japanese Patent Application Laid-open No. 2022-130369 also discloses a configuration for preventing toner leakage by sealing the space between the frame body and the developing blade unit with a sealing member by injecting the sealing member, into the frame body through a second cutout portion provided to the blade support member.

### SUMMARY OF THE INVENTION

In such a configuration, the blade support member has a shape provided not only with the first cutout portion for positioning the developing blade unit in the longitudinal direction of the developing apparatus, but also with the second cutout portion for forming an opening for injecting the sealing member (Japanese Patent Application Laid-open No. 2022-130369). However, when a plurality of cutout portions is provided to the blade support member, there are concerns that the rigidity of the blade support member may decrease, as well as that the longitudinal width of the blade support member may need to be designed longer in order to ensure the longitudinal width for the cutout portions.

An object of the present invention is to provide a technology for ensuring the rigidity of, and being capable of achieving a size reduction in the regulating member.

To address the objective described above, a developing apparatus according to the present invention includes:
a frame body having a storage chamber for storing developer, and provided with an opening portion communicating with the storage chamber;
a developing roller disposed in a manner facing the opening portion, and supported rotatably by the frame body about a rotation axis;
a regulating unit regulating a layer thickness of the developer borne on an outer circumferential surface of the developing roller, with the regulating unit including a sliding member coming into sliding contact with the outer circumferential surface of the developing roller, and a support member for supporting the sliding member; and
a sealing member sealing a space between the frame body and the regulating unit, in a first end of the frame body in a direction of the rotation axis,
wherein the support member has a recessed portion that is recessed in a direction intersecting with the rotation axis, and that is provided to an end of the support member on a side the same as the first end of the frame body, in the direction of the rotation axis, the recessed portion being constituted by surfaces including a first side surface and a second side surface that extend in the direction intersecting,
wherein the frame body has protruding portions that includes a first protruding portion and a second protruding portion that are aligned with respect to each other between the first side surface and the second side surface, with a gap between the first protruding portion and the second protruding portion in the direction of the rotation axis, and protruding in a direction intersecting with the rotation axis,
wherein, by an engagement between the protruding portion and the recessed portion, the support member is positioned with respect to the frame body in the direction of the rotation axis, and
wherein the space communicates with outside of the frame body via the gap. Furthermore, also to address the objective described above, a cartridge that is removable from the apparatus main body of an image forming apparatus according to the present invention includes:
an image bearing member; and
the developing apparatus of the present invention.

According to the present invention, it is possible to ensure the rigidity in, and to achieve a size reduction of the regulating member.

Further features of the present invention will become apparent from the following description of exemplary embodiments with reference to the attached drawings.

### BRIEF DESCRIPTION OF THE DRAWINGS

FIG. 1 is a schematic for explaining configurations of a developing blade unit and a developing frame body according to an embodiment;

FIG. 2 is a schematic sectional view of an image forming apparatus according to the embodiment;

FIG. 3 is a sectional view of a process cartridge according to the embodiment;

FIG. 4 is a sectional view of an image forming apparatus according to the embodiment;

FIG. 5 is an exploded perspective view of a drum unit according to the embodiment;

FIG. 6 is an exploded perspective view of a developing unit according to the embodiment;

FIG. 7 is a perspective view for assembling a process cartridge according to the embodiment;

FIG. 8 is a perspective view of the process cartridge according to the embodiment;

FIG. 9A is a perspective view, and FIG. 9B is a side view of the developing blade unit according to the embodiment;

FIG. 10 is a perspective view for explaining the shape of the developing frame body according to the embodiment;

FIG. 11 is a perspective view for explaining a configuration for positioning the developing blade unit according to the embodiment;

FIGS. 12A to 12C are schematics for explaining a configuration of a seal according to the embodiment;

FIG. 13 is a schematic for explaining a configuration of the seal according to the embodiment;

FIG. 14 is a sectional view for explaining a configuration of a toner sealing member according to the embodiment; and

FIG. 15 is a perspective view for explaining a configuration of the toner sealing member according to the embodiment.

### DESCRIPTION OF THE EMBODIMENTS

Modes for implementing the present invention will now be explained specifically and illustratively with reference to drawings, on the basis of some embodiments. The sizes, the materials, the shapes, and the relative positioning of the elements described in the following embodiments are intended to be changed as appropriate, depending on the configuration of an apparatus to which the present invention is applied, or on various conditions. In other words, the embodiments are not intended to limit the scope of the present invention in any way. Furthermore, a plurality of features are described in the embodiments, but not all of such a plurality of features are necessarily essential to the present invention, and the plurality of features may be combined in any way. In the appended drawings, the same or similar configurations are given the same reference numerals, and redundant explanations thereof will be omitted.

### First Embodiment

An electrophotographic image forming apparatus (hereinafter, also referred to as an “image forming apparatus”) according to a first embodiment of the present invention will now be explained with reference to drawings. An electrophotographic image forming apparatus is an apparatus for forming an image on a sheet-like recording medium, such as a paper sheet, using electrophotography. Specific examples of the image forming apparatus include a copier, a facsimile apparatus, and a printer (such as a laser-beam printer and an LED printer), and a combination thereof (multifunction printer). Examples of the recording medium include recording paper and a sheet-like recording medium such as a plastic sheet. In the embodiments below, a description of a laser beam printer is provided as an exemplary embodiment of the image forming apparatus.

In the first embodiment, an image forming apparatus in which four toner cartridges and four process cartridges are provided as removable cartridges will be explained as an example of the image forming apparatus. The numbers of the toner cartridges and the process cartridges to be mounted on the image forming apparatus are not limited thereto, and are intended to be set as appropriate, on the basis of requirements.

A cartridge is a unit fixed to or removable from the image forming apparatus described above (the removable unit will be also referred to as a cartridge). Such a unit may be configured as a process unit with means for exerting an effect to a photosensitive element (e.g., a charging member, a developing member, or a cleaning member), or a unit with toner. In other words, the cartridge may take various forms. Possible configurations of the cartridge include a configuration for replacing the drum unit and the developing unit that are integrated as an all-in-one cartridge, and a configuration for replacing the drum unit and the developing unit, individually. Another possible configuration includes a configuration for enabling a user to replace a toner container storing therein the toner, when the toner container is out of the toner, while process cartridges other than the toner container are fixed to the image forming apparatus, and a configuration for replacing the process cartridges as well as the toner container.

### General Configuration of Image Forming Apparatus

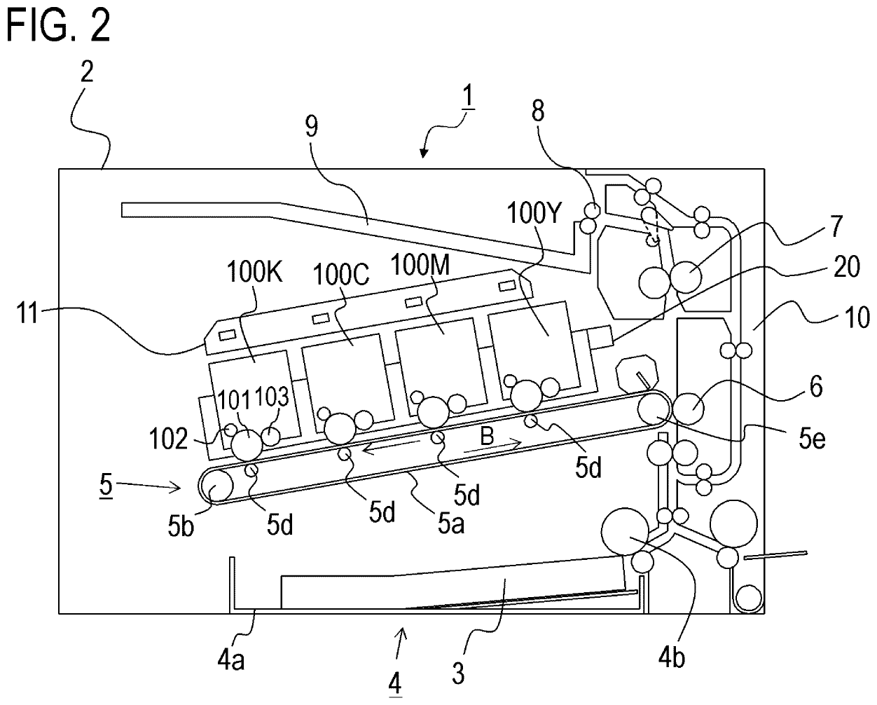

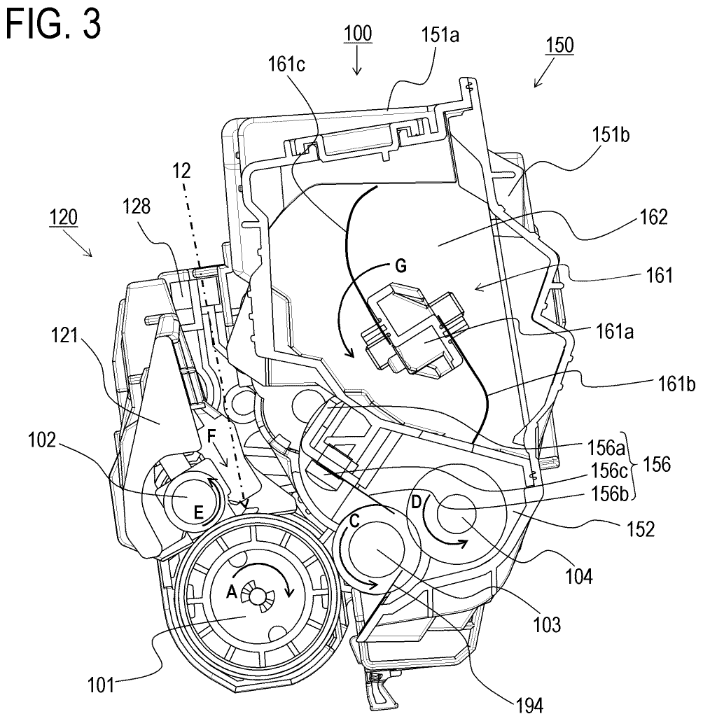

An overall configuration of an image forming apparatus 1 according to the embodiment will now be explained with reference to FIGS. 2 and 3. FIG. 2 is a sectional view schematically illustrating a general configuration of the image forming apparatus 1. FIG. 3 is a schematic sectional view of a process cartridge 100.

This image forming apparatus 1 is a four full-color laser beam printer using electrophotography, and forms a color image on a recording medium 3. The image forming apparatus 1 forms a color image on the recording medium 3 using the process cartridge 100 that is removably mounted on an apparatus main body 2 of the image forming apparatus 1.

In the description herein, the side of the image forming apparatus 1 provided with a front door 10 will be referred to as a front surface (front face), and the surface on the opposite side of the front surface will be referred to as a rear surface (rear face). The right-hand side of the image forming apparatus 1 in a view from the side of the front surface will be referred to a driving side, and the left-hand side will be referred to as a non-driving side. The side on the top will be referred to as a top surface, and the side on the bottom will be referred to as a bottom surface. FIG. 2 is a sectional view of the image forming apparatus 1 in a view from the non-driving side. In FIG. 2, a near side with respect to the picture plane of FIG. 2 corresponds to the non-driving side of the image forming apparatus 1; the right-hand side with respect to the picture plane corresponds to the front surface of the image forming apparatus 1; and the far side with respect to the picture plane corresponds to the driving side of the image forming apparatus 1.

The driving side of the process cartridge 100 is a side provided with a drum coupling member (photosensitive body coupling member), which will be described later, in an axial direction of the photosensitive drum (the direction in which the rotation axis of the photosensitive drum extends). The driving side of the process cartridge 100 also is a side provided with a developing coupling member, which will be described later, in an axial direction of the developing roller (developing member) (in the direction in which the rotation axis of the developing roller extends). The axial direction of the photosensitive drum is parallel with the axial direction of the developing roller, as well as with the longitudinal direction of the process cartridge 100.

In the image forming apparatus main body 2, first to fourth process cartridges 100 (100Y, 100M, 100C, 100K) are arranged substantially in a horizontal direction. The first to the fourth process cartridges 100 (100Y, 100M, 100C, 100K) all have the same electrophotographic processing mechanism, with each cartridge filled with a different amount of a developer (hereinafter, referred to as toner) of a different color. Therefore, when it is not particularly necessary to distinguish one from the others, the subscripts Y to K will be omitted, and these process cartridges 100 will be explained at once.

The first to the fourth process cartridges 100 receive a rotating driving force transmitted from a drive output portion (to be described later in detail) included in the image forming apparatus main body 2. The first to the fourth process cartridges 100 are also supplied with bias voltages (such as a charging bias, a developing bias, a remaining electrostatic electricity detection bias) via a contact point (not illustrated) included in the image forming apparatus main body 2.

As illustrated in FIG. 3, each of the process cartridges 100 according to this embodiment includes a drum unit 120 that includes a photosensitive drum 101 and a charging unit, which is means for processing exerting an effect to the photosensitive drum 101. In addition to the charging unit, the drum unit 120 may also include a cleaning unit, as means for processing. Each of the process cartridges 100 also includes a developing unit (developing apparatus) 150 provided with a developing portion, by which an electrostatic image on the photosensitive drum 101 is developed.

In each of the process cartridges 100, the drum unit 120 and the developing unit 150 are coupled to each other. A specific configuration of the process cartridge 100 will be described later.

The first process cartridge 100Y stores therein a yellow (Y) toner inside a developing frame body, and forms a yellow toner image on the surface of the photosensitive drum 101. The second process cartridge 100M stores therein a magenta (M) toner inside the developing frame body, and forms a magenta toner image on the surface of the photosensitive drum 101. The third process cartridge 100C stores therein a cyan (C) toner inside the developing frame body, and forms a cyan toner image on the surface of the photosensitive drum 101. The fourth process cartridge 100K stores therein a black (K) toner inside the developing frame body, and forms a black toner image on the surface of the photosensitive drum 101.

As illustrated in FIG. 2, above the first to the fourth process cartridges 100, a laser scanner unit 11 that is a exposing unit is provided. This laser scanner unit 11 outputs a laser beam 12 (FIG. 3) in accordance with image information. The laser beam 12 is scanned across the surface of the photosensitive drum 101, so that the surface is exposed therewith, through an exposure window 128 provided to the process cartridge 100, as illustrated in FIG. 3.

Below the first to the fourth process cartridges 100, an intermediate transfer unit 5 that is a transfer member is provided. This intermediate transfer unit 5 includes a driver roller 5e and a tension roller 5b, and a transfer belt 5a (intermediate transfer belt) that is flexible, and is stretched across these rollers. The photosensitive drum 101 in each of the first to the fourth process cartridges 100 has a downward-facing area, on the circumferential surface thereof, that is in contact with an upward-facing area of the outer circumferential surface of the annular transfer belt 5a. This contact region forms a primary transfer portion. On the inner side of the transfer belt 5a, a primary transfer roller 5d is provided, in a manner facing the photosensitive drum 101. A secondary transfer roller 6 is held in contact with the driver roller 5e, with the transfer belt 5a interposed therebetween. This contact region between the transfer belt 5a and the secondary transfer roller 6 forms a secondary transfer portion.

Below the intermediate transfer unit 5, a feeding unit 4 is provided. The feeding unit 4 includes a paper feeding tray 4a where a stack of recording media 3 is stored, and a paper feeding roller 4b.

On the upper right-hand side of the apparatus main body 2 in FIG. 2, a fixing apparatus 7 and a paper ejecting apparatus 8 are provided, and the top surface of the apparatus main body 2 provides a paper ejecting tray 9. A conveyance route for the recording medium S extends substantially upwards from the feeding unit 4, on the front side of the apparatus, inside the apparatus main body 2.

On the downstream side of the secondary transfer portion in the conveyance route of the recording medium 3 (on the upper right side inside the apparatus main body 2 in FIG. 2) the fixing apparatus 7 and the paper ejecting apparatus 8 are provided. The top surface of the apparatus main body 2 provides a paper ejecting tray 9. By causing a fixing unit included in the fixing apparatus 7 to press and heat the recording medium 3, the toner image is fixed onto a recording medium 3, and then the recording medium 3 is ejected onto the paper ejecting tray 9.

### Image Forming Operation

An operation for forming a full-color image is as follows. The photosensitive drums 101 included in the respective first to fourth process cartridges 100 are driven in rotation at a predetermined speed (in the direction of the arrow A in FIG. 3). The transfer belt 5a is also driven in rotation in a direction following the direction of the rotation of the photosensitive drums 101 (in the direction of the arrow B in FIG. 2), at a speed corresponding to the speed of the photosensitive drums 101.

The laser scanner unit 11 is also driven. Synchronously with driving of the laser scanner unit 11, charging rollers 102 included in the respective process cartridges 100 charge the surfaces of the respective photosensitive drums 101 uniformly to a predetermined potential at a predetermined polarity. The laser scanner unit 11 scans across the surface of each of the photosensitive drums 101 and exposes the surface with a laser beam 12, on the basis of an image signal of the corresponding color. In this manner, an electrostatic latent image corresponding to the image signal of that color is formed on the surface of the photosensitive drum 101. The electrostatic image thus formed is developed by the developing roller 103 driven in rotation in the direction following the direction of the rotation of the photosensitive drums 101 (in the direction of the arrow C in FIG. 3), at a predetermined speed. Through the operation of the electrophotographic process described above, a yellow toner image corresponding to a yellow component of the full-color image is formed on the photosensitive drum 101 in the first process cartridge 100Y. The toner image is then primarily transferred onto the transfer belt 5a.

In the same manner, a magenta toner image corresponding to a magenta component of the full-color image is formed on the photosensitive drum 101, in the second process cartridge 100M. The toner image is then primarily transferred in a manner superimposed over the yellow toner image having been already transferred onto the transfer belt 5a. In the same manner, a cyan toner image corresponding to a cyan component of the full-color image is formed on the photosensitive drum 101, in the third process cartridge 100C. The toner image is then primarily transferred in a manner superimposed over the yellow and the magenta toner images having been already transferred onto the transfer belt 5a. In the same manner, a black toner image corresponding to a black component of the full-color image is formed on the photosensitive drum 101, in the fourth process cartridge 100K. The toner image is then primarily transferred in a manner superimposed over the yellow toner image, the magenta toner image, and the cyan toner image having been already transferred onto the transfer belt 5a. In the manner described above, a full-color unfixed toner image including the four colors of yellow, magenta, cyan, and black is formed on the transfer belt 5a.

Meanwhile, at a predetermined control timing, a recording medium 3 is separated and fed, one sheet at a time. The recording medium 3 is then guided into the secondary transfer portion that is the contact region between the secondary transfer roller 6 and the transfer belt 5a, at a predetermined control timing. With this, through the process of conveying the recording medium 3 into the secondary transfer portion, the four-color toner images on the transfer belt 5a are transferred onto the recording medium 3, sequentially at once. The recording medium 3 is then conveyed to the fixing apparatus 7, has the toner image fixed thereto, and then ejected onto the paper ejecting tray 9.

### General Description of Configuration for Removing and Mounting Process Cartridge

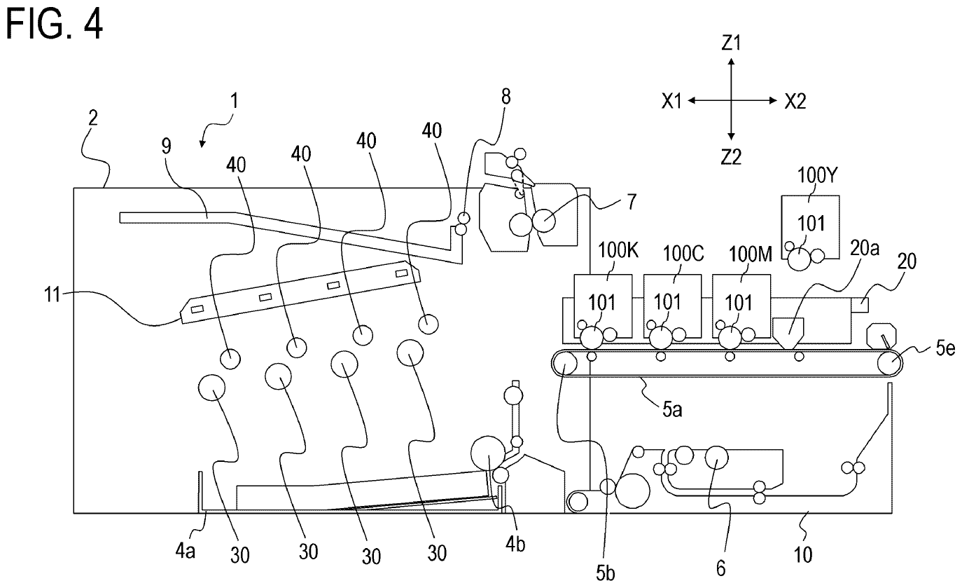

A cartridge tray 20 (hereinafter, referred to as a tray 20) for supporting the process cartridge 100 will now be explained more in detail with reference to FIG. 4. FIG. 4 is a sectional view of the image forming apparatus 1 with the tray 20 disposed outside of the apparatus main body 2, with the front door 10 opened, and with the process cartridge 100 being removed from the tray 20.

The tray 20 is movable in the directions of the arrow X1 (pushing direction) and the arrow X2 (pulling direction) that are substantially horizontal directions, with respect to the image forming apparatus main body 2. In other words, the tray 20 is provided in a manner enabled to be pulled out of and pushed into the apparatus main body 2, and the tray 20 is movable in the substantially horizontal directions, with the image forming apparatus main body 2 installed on a horizontal surface. This position of the tray 20 on the inner side of the apparatus main body 2 with the front door 10 opened will be referred to as an inner position. This position of the tray 20 outside of the apparatus main body 2 will be referred to as an outer position. At the inner position and the outer position, the photosensitive drums 101 and the transfer belt 5a are separated from each other.

The tray 20 also has, as illustrated in FIG. 4, an attachment portion 20a allowing the first process cartridge 100Y to be mounted, in a manner allowing the first process cartridge 100Y to be removed at the outer position. In the same manner, the tray 20 also includes attachment portions 20a enabling the second to the fourth process cartridges 100M, 100C, 100K to be mounted removably, respectively. As the tray 20 is moved, the process cartridges 100 disposed on the respective attachment portions 20a move into the image forming apparatus main body 2. In this embodiment, by closing the front door 10, a link mechanism, not illustrated, is caused to move the intermediate transfer unit 5 upwards in the direction of the arrow Z1, to the position for forming an image (the position where the photosensitive drums 101 and the transfer belt 5a come into contact with each other). By opening the front door 10, the intermediate transfer unit 5 is caused to move downwards in the direction of the arrow Z2, and the photosensitive drums 101 and the transfer belt 5a separate from each other.

As described above, by using the tray 20, it is possible to move all of a plurality of the process cartridges 100 at once, to a position where images can be formed, inside the image forming apparatus main body 2, and to be pulled outside of the image forming apparatus main body 2 at once.

### Overall Configuration of Process Cartridge

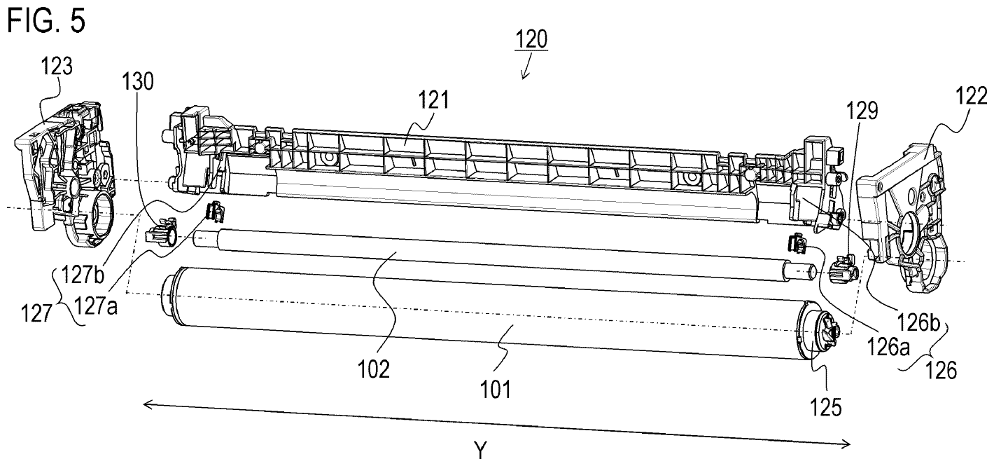

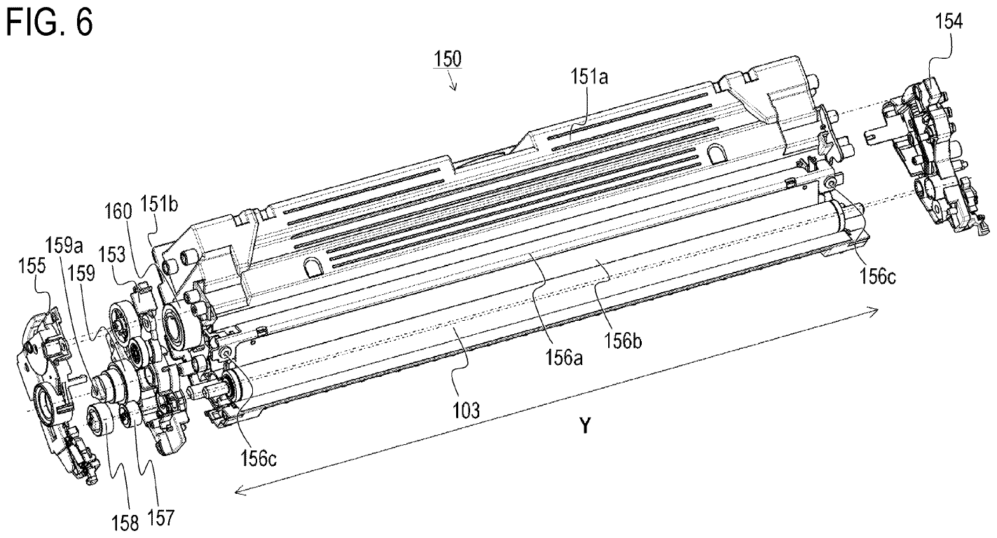

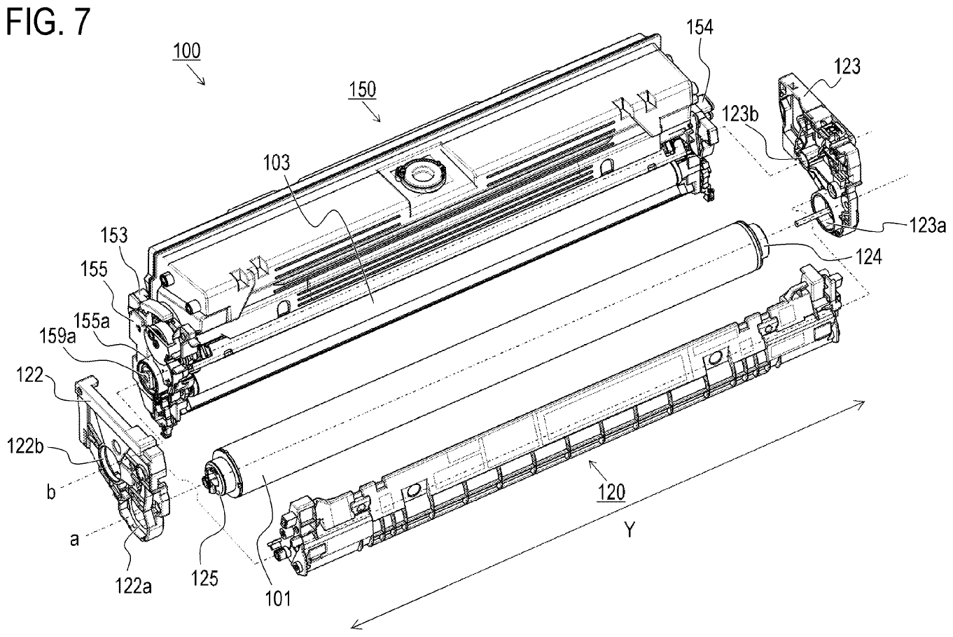

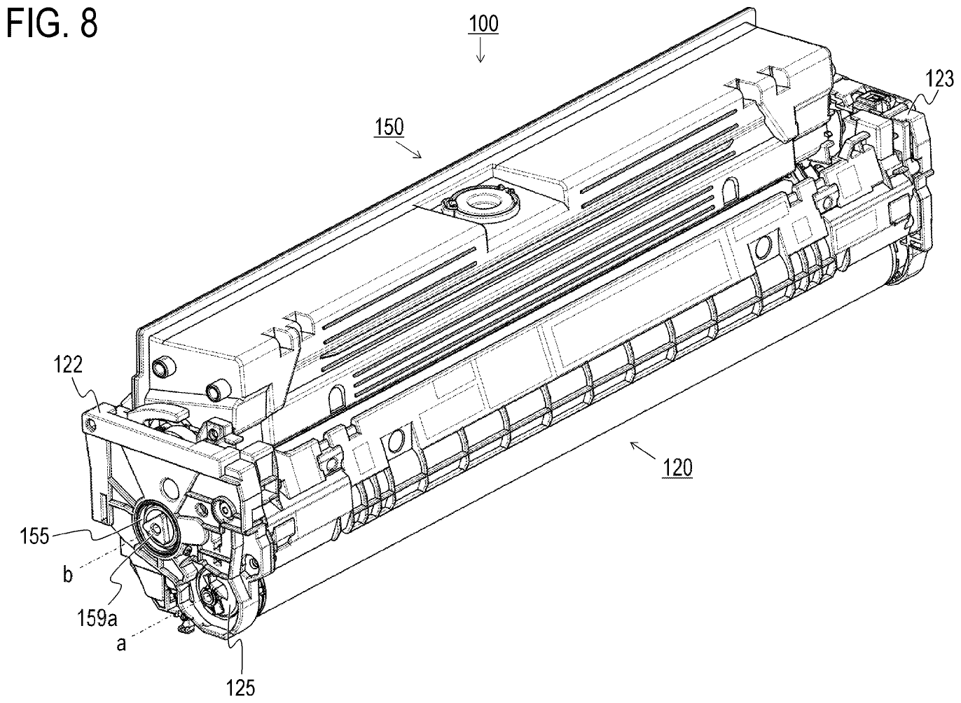

A configuration of the process cartridge 100 will now be explained with reference to FIGS. 5 to 8. FIG. 5 is an exploded perspective view of the drum unit 120. FIG. 6 is an exploded perspective view of the developing unit 150. FIG. 7 is a perspective view for assembling the process cartridge 100, in a view from the driving side that is a one-end side of the photosensitive drum 101 in the axial direction. FIG. 8 is a perspective view of the process cartridge 100 in a view from the driving side.

The process cartridge 100 is provided with the photosensitive drum 101, and processing units exerting an effect to the photosensitive drum 101. Examples of the processing units herein include the charging roller 102 that is the charging member for charging the photosensitive drum 101, and the developing roller 103 that is the developing member for developing a latent image being borne on the photosensitive drum 101. The process cartridge 100 is divided into the drum unit 120 and the developing unit 150.

In the description below, the longitudinal direction Y of the drum unit 120 and the developing unit 150 is a direction substantially in parallel with the rotation axis a of the photosensitive drum 101 (FIG. 7).

### Configuration of Drum Unit

As illustrated in FIGS. 5 and 7, the drum unit 120 includes the photosensitive drum 101, the charging roller 102, and a drum frame body 121. The charging roller 102 is rotatably supported by a driving-side charging roller bearing 126a and a non-driving-side charging roller bearing 127a, and is biased against the photosensitive drum 101 (in the direction of the arrow F in FIG. 3) by pressing springs 126b, 127b. On a driving-side end that is one end of the charging roller 102 in the longitudinal direction, a driving-side charging roller separator member 129 is attached, and, on a non-driving side end that is the other end, a non-driving side charging roller separator member 130 is attached. These separator members 129, 130 keep the charging roller 102 separated from the photosensitive drum 101 at the time of initial shipment. This separation is removed by the rotation of the photosensitive drum 101 when the drum unit 120 is put in use.

The photosensitive drum 101 is rotatably supported by a driving-side cartridge cover member 122 provided to one end of the process cartridge 100 and a non-driving-side cartridge cover member 123 provided to the other end in the longitudinal direction.

As illustrated in FIG. 7, one end of the photosensitive drum 101 in the longitudinal direction is provided with a coupling member 125 via which a driving force is communicated to the photosensitive drum 101. The coupling member 125 is coupled with a main body side drum driving coupling 30 (see FIG. 4) serving as a drum drive output portion in the apparatus main body 2, so that the driving force of a driving motor (not illustrated) included in the apparatus main body 2 is transmitted to the photosensitive drum 101 to cause the photosensitive drum 101 to rotate in the direction of the arrow A in FIG. 3. The photosensitive drum 101 also has a drum flange 124 on the side of the other end in the longitudinal direction. The driving-side charging roller bearing 126a and the non-driving-side charging roller bearing 127a supporting the charging roller 102 are supported on the drum frame body 121, in a manner enabling the charging roller 102 to come into contact with and be driven by the photosensitive drum 101 (in the direction of the arrow E in FIG. 3).

### Configuration of Developing Unit

The developing unit 150 includes, as illustrated in FIGS. 3 and 6, the developing roller 103, the developer supplying roller 104, a developing blade unit 156, and the developing frame body 151. The developing frame body 151 includes a first developing frame body 151a and a second developing frame body 151b. The developing frame body 151 is formed by bonding the first developing frame body 151a and the second developing frame body 151b by ultrasonic bonding, for example.

The developing frame body 151 has a developing chamber 152 that is a storage chamber where the developing roller 103 and the developer supplying roller 104 are disposed, and a toner storage portion 162 storing therein the toner to be supplied to the developing roller 103. The developing frame body 151 supports the developing roller 103 and the developer supplying roller 104 rotatably, via a driving-side bearing 153 and a non-driving side bearing 154. In the toner storage portion 162 of the developing frame body 151, a stirring member 161 is provided rotatably. The developing frame body 151 also holds the developing blade unit 156 for regulating the thickness of the toner layer to be borne on the circumferential surface of the developing roller 103.

One end of the developing unit 150 in the longitudinal direction is provided with a developing driving input gear 159 for transmitting the driving force to the developing unit 150. The developing driving input gear 159 is provided with a developing input coupling 159a for receiving a driving force from a main-body-side developing driving coupling 40 on the image forming apparatus main body 2 (FIG. 4), and the driving force of the driving motor (not illustrated) in the image forming apparatus main body 2 is thus input to the developing unit 150.

The driving force input to the developing unit 150 is transmitted to a developing roller gear 157, to cause the developing roller 103 to rotate in the direction of the arrow C in FIG. 3. The driving force input to the developing unit 150 is also transmitted to a developer supplying roller gear 158, to cause the developer supplying roller 104 to rotate in the direction of the arrow D in FIG. 3. The driving force input to the developing unit 150 is also transmitted to a stirring gear 160, to cause a stirring member 161 to rotate in the direction of the arrow G in FIG. 3, so that the toner in the toner storage portion 162 is stirred thereby.

The stirring member 161 includes a rotation shaft 161a extending in parallel with the direction of the rotational axis of the developing roller 103, and stirring sheets 161b, 161c serving as conveying members that are flexible sheets. Each of the stirring sheets 161b, 161c has one end attached to the rotation shaft 161a, and has the other end as a free end. As the rotation shaft 161a is rotated and causes the stirring sheets 161b, 161c to rotate, the toner inside the toner storage portion 162 is stirred by the stirring sheets 161b, 161c.

The one-end side of the developing unit 150 in the longitudinal direction is provided with a developing cover member 155 that supports and covers the developing driving input gear 159.

### Assembling of Drum Unit and Developing Unit

Assembling of the drum unit 120 and the developing unit 150 will now be explained with reference to FIG. 7. Using the driving-side cartridge cover member 122 provided to one end of the process cartridge 100 in the longitudinal direction and the non-driving-side cartridge cover member 123 provided to the other end, the drum unit 120 and the developing unit 150 are coupled with each other.

The driving-side cartridge cover member 122, which is provided to the one-end side of the process cartridge 100 in the longitudinal direction, has a developing unit supporting hole 122b for swingably (movably) supporting the developing unit 150. Similarly, the non-driving-side cartridge cover member 123, which is provided to the other-end side of the process cartridge 100 in the longitudinal direction, has a developing unit supporting hole 123b for swingably supporting the developing unit 150. The driving-side cartridge cover member 122 and the non-driving-side cartridge cover member 123 also have a drum supporting hole 122a and a drum supporting hole 123a, respectively, for rotatably supporting the photosensitive drum 101.

On the one-end side, the external circumference of a cylindrical portion 155a that is provided to the developing cover member 155 is fitted into the developing unit supporting hole 122b provided to the driving-side cartridge cover member 122. On the other-end side, the external circumference of a cylindrical portion (not illustrated) that is provided to the non-driving-side bearing 154 is fitted into the developing unit supporting hole 123b provided to the non-driving-side cartridge cover member 123. The one end of the photosensitive drum 101 in the longitudinal direction is also fitted into the drum supporting hole 122a of the driving-side cartridge cover member 122, and the other end is fitted into the drum supporting hole 123a of the non-driving-side cartridge cover member 123. The driving-side cartridge cover member 122 and the non-driving-side cartridge cover member 123 are then fixed to the drum unit 120 using screws or adhesive, not illustrated. In this manner, the driving-side cartridge cover member 122 and the non-driving-side cartridge cover member 123 rotatably support the developing unit 150 with respect to the drum unit 120 (the photosensitive drum 101). During the image formation, by rotating the developing unit 150 with respect to the drum unit 120, the developing roller 103 can be brought to a position where the effect is exerted to the photosensitive drum 101.

FIG. 8 illustrates the process cartridge 100 resultant of assembling the drum unit 120 and the developing unit 150 as one unit, through the process described above. An axial line that connects the center of the developing unit supporting hole 122b of the driving-side cartridge cover member 122 and the center of the developing unit supporting hole 123b of the non-driving-side cartridge cover member 123 will be referred to as a swinging axis b. At this time, the cylindrical portion 155a, which is on the one-end side of the developing cover member 155, and the developing input coupling 159a are on the same axis. In other words, the developing unit 150 is configured to receive a rotating driving force about the swinging axis b, from the apparatus main body 2. About the swinging axis b, the developing unit 150 is also pivotably supported.

### Configuration of Developing Blade Unit

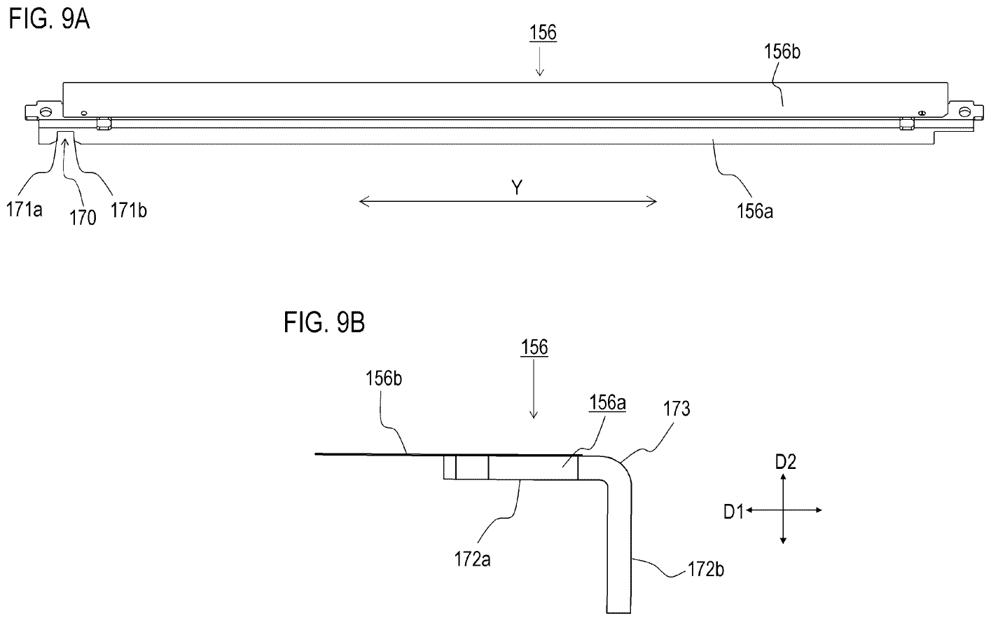

A configuration of the developing blade unit 156 will now be explained with reference to FIGS. 9A and 9B. FIG. 9A is a schematic of the developing blade unit 156 in a view in the direction orthogonal to the longitudinal direction of the developing blade unit 156 (orthogonal to a direction parallel with the rotation axis of the developing roller 103). FIG. 9B is a side view of the developing blade unit 156, in a view along the longitudinal direction of the developing blade unit 156.

As illustrated in FIG. 9A, the developing blade unit 156 includes a blade support member 156a that is a fixed member fixed to the developing frame body 151, and a blade member 156b that is supported by the blade support member 156a and is a sliding member that slides along in contact with the circumferential surface of the rotating developing roller 103. The blade member 156b is a sheet metal having a thickness of 0.1 mm or so, and attached to the blade support member 156a that is made of a metal material having L-shaped cross section.

As illustrated in FIG. 9B, the blade support member 156a has a first support portion 172a installed in contact with the developing frame body 151, and a second support portion 172b provided to the first support portion 172a with a bent portion 173 therebetween. The second support portion 172b is provided with a cutout portion 170 into which a developing blade positioning portion 180, to be described later, is fitted, and that is used in positioning. The cutout portion 170 is provided to one end of the blade support member 156a in the longitudinal direction. The one end of the blade support member 156a in the longitudinal direction is the end on the side the same as the non-driving side end that is a first end of the developing frame body 151 in the longitudinal direction. The cutout portion 170 is a recessed portion recessed in a direction orthogonal to the longitudinal direction of the blade support member 156a, and constituted by surfaces including a first regulating surface 171a and a second regulating surface 171b that extend in the direction orthogonal to the longitudinal direction of the blade support member 156a.

The ends of the first support portion 172a in the longitudinal direction Y are fixed to the developing frame body 151, with screws 174, respectively. The first support portion 172a extends in a first direction D1 orthogonal to the longitudinal direction Y. The second support portion 172b extends from one end the first support portion 172a in the first direction D1, along a second direction D2 that is orthogonal to both of the longitudinal direction Y and the first direction D1. The blade member 156b is attached to the first support portion 172a in a manner jutting out in the first direction D1, from the other end of the first support portion 172a in the first direction D1. The cutout portion 170 is provided, in a manner recessed in the second direction D2, to the end of the second support portion 172b on the opposite side of the end connected to the first support portion 172a. The first regulating surface 171a that is a first side surface of the cutout portion 170 and the second regulating surface 171b that is a second side surface are surfaces each extending in a direction orthogonal to the longitudinal direction Y (rotation axis), and face each other in the direction of the rotation axis.

In this embodiment, the first direction D1, the second direction D2, and the longitudinal direction Y (direction of the rotation axis) are orthogonal to each other, but these directions may intersect at an angle somewhat deviating from the right angle. In other words, the angles formed by the first direction D1, the second direction D2, and the longitudinal direction Y (direction of the rotation axis) may be an angle at which these directions intersect each other, without limitation to the orthogonal (right angle).

### Configuration for Positioning Developing Blade Unit

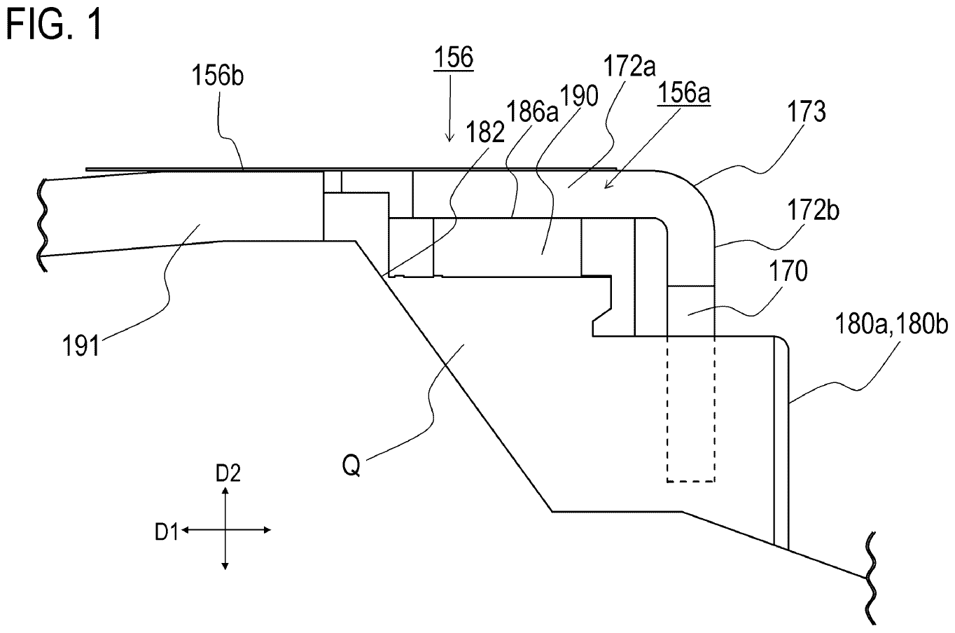

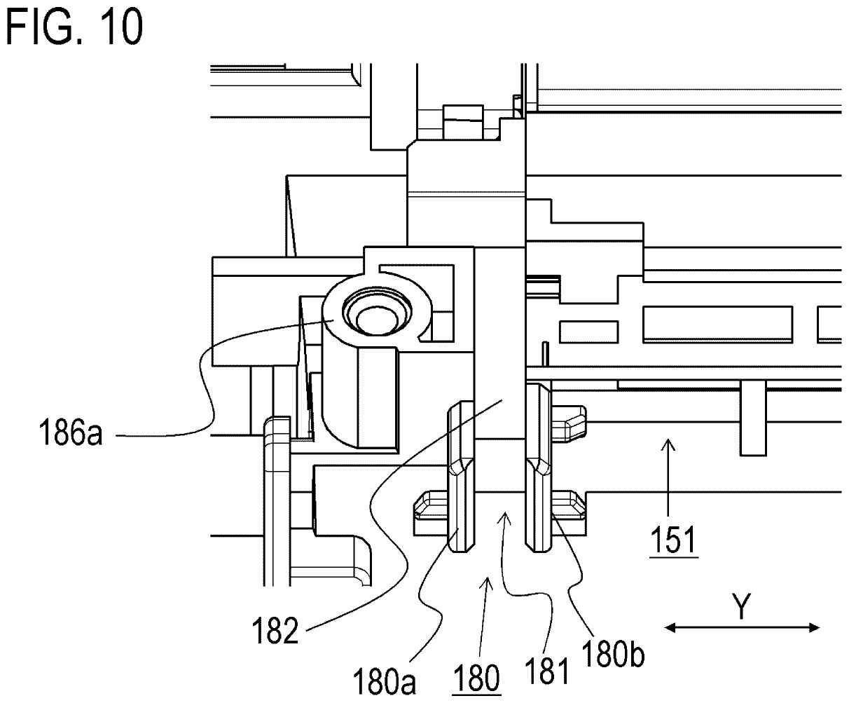

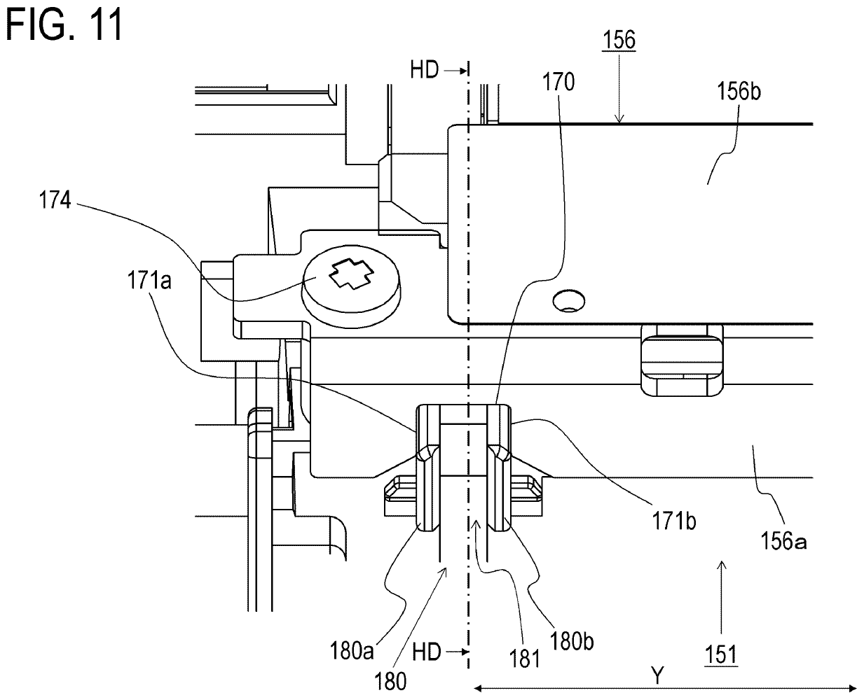

A configuration for positioning the developing blade unit 156 will now be explained with reference to FIGS. 1, 10, and 11. FIG. 10 is a perspective view illustrating the shape around the developing blade positioning portion 180 provided to the developing frame body 151. FIG. 11 is a perspective view illustrating a configuration for positioning the developing blade unit 156 with respect to the developing frame body 151. FIG. 1 is a cross section across HD-HD in FIG. 11, and is a sectional view of the configuration of the developing frame body 151, the developing blade unit 156, a developing blade bottom seal 190, and an end seal 191. For the purpose of explanation, screws 174 are not illustrated in FIG. 1

As illustrated in FIG. 10, the developing frame body 151 includes the developing blade positioning portion 180 capable of positioning the developing blade unit 156 in the longitudinal direction. The developing blade positioning portions 180 are protruding portions having a first protruding portion 180a and a second protruding portion 180b. The first protruding portion 180a that is a first protruding portion protrudes in a direction orthogonal to the longitudinal direction Y, and faces the first regulating surface 171a of the cutout portion 170 in the longitudinal direction Y. The second protruding portion 180b that is a second protruding portion protrudes in a direction orthogonal to the longitudinal direction Y, and faces the second regulating surface 171b in the longitudinal direction Y. The first protruding portion 180a and the second protruding portion 180b are aligned with respect to each other between the first regulating surface 171a and the second regulating surface 171b, with a gap therebetween in the longitudinal direction Y.

In this embodiment, the direction in which the cutout portion 170 is recessed and the direction in which the first protruding portion 180a and the second protruding portion 180b protrude are orthogonal to the longitudinal direction Y (the direction of the rotation axis), but this angle may be an angle somewhat deviating from the right angle. In other words, the angle formed by the direction in which the cutout portion 170 is recessed and the first protruding portion 180a and the second protruding portion 180b protrude with the longitudinal direction Y (the direction of the rotation axis) may be an angle at which these directions intersect each other, without limitation to the orthogonal (right angle).

In the region between the first protruding portion 180a and the second protruding portion 180b in the longitudinal direction Y of the cartridge, a recessed portion 181 is formed. This recessed portion 181 functions as a filling opening for filling a toner sealing member 192, to be described later, into a space Q that is a gap between the developing frame body 151 and the developing blade unit 156, at the longitudinal end of the developing frame body 151 (details of which will be described later). In other words, the space Q to be sealed with the toner sealing member 192 is connected to the outside of the developing frame body 151 via the recessed portion 181 that is the gap between the first protruding portion 180a and the second protruding portion 180b in the longitudinal direction Y. The toner sealing member 192 is visible from the outside of the developing frame body 151 through the recessed portion 181.

The recessed portion 181 of the developing frame body 151 is inclined with respect to the direction in which the first support portion 172a of the blade support member 156a illustrated in FIG. 1 extends, and is continuous to an inclined surface 182 for guiding the direction in which the toner sealing member 192, to be described later, flows. The inclined surface 182 is a part of the surface of the developing frame body 151 defining the space Q between the developing frame body 151 and the developing blade unit 156, and is a surface facing the first support portion 172a. The inclined surface 182 is a surface extending in a direction inclined with respect to both of the first direction D1 and the second direction D2, being inclined in a manner gradually approaching the first support portion 172a as the inclined surface 182 extends in the direction in which the blade member 156b protrudes from the first support portion 172a.

As illustrated in FIG. 11, in the process of assembling the developing blade unit 156 to the developing frame body 151, the developing blade positioning portion 180 provided to the developing frame body 151 is fitted into the cutout portion 170 provided to the blade support member 156a. More specifically, the first protruding portion 180a of the developing frame body 151 is mated with the first regulating surface 171a of the blade support member 156a, and the second protruding portion 180b of the developing frame body 151 is mated with the second regulating surface 171b of the blade support member 156a. With this, the developing blade unit 156 is positioned with respect to the developing frame body 151, with a movement thereof with respect to the developing frame body 151 in the longitudinal direction regulated. Both ends of the blade support member 156a are then fixed to the developing frame body 151 with the screws 174.

As illustrated in FIG. 1, with the blade support member 156a assembled to the developing frame body 151, the end faces of the first protruding portion 180a and the second protruding portion 180b jut out from the second support portion 172b of the blade support member 156a in a direction orthogonal to the direction in which the second support portion 172b extends. In other words, the first protruding portion 180a and the second protruding portion 180b protruding from the developing frame body 151 extend more outwards than the second support portion 172b, in the first direction D1. To put in other words, the first protruding portion 180a and the second protruding portion 180b forming the opening for guiding the toner sealing member 192 are provided in the manner extending from a side outer than the second support portion 172b with respect to the developing frame body 151, to a side nearer to the space Q than the second support portion 172b, in the first direction D1.

### Configuration for Sealing Toner

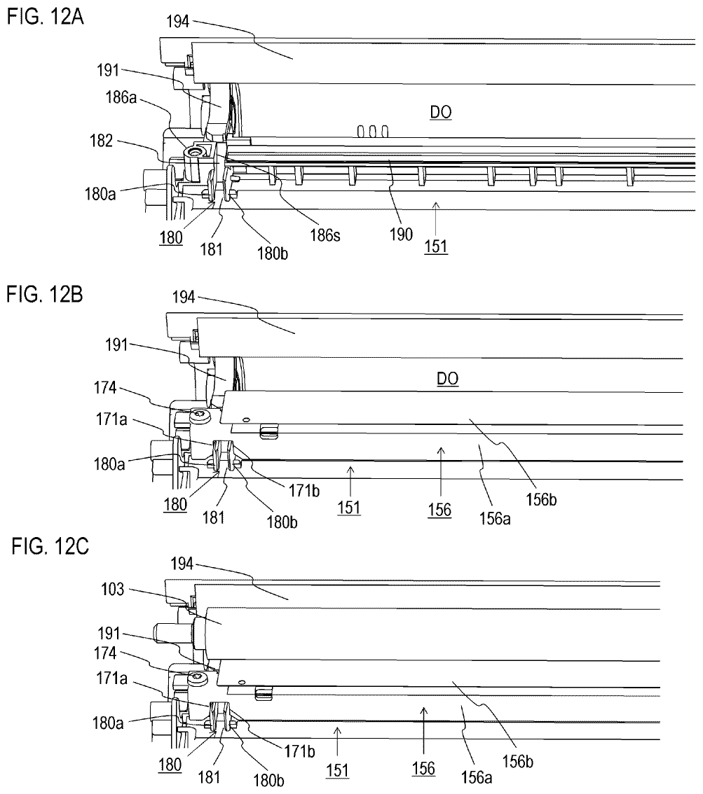

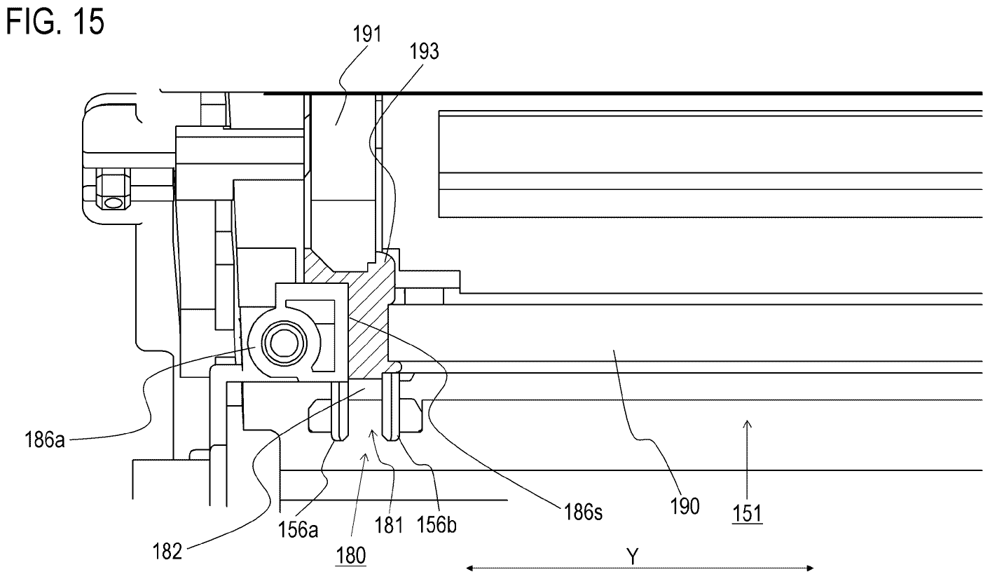

Configurations of the developing frame body 151, the developing blade unit 156, the developing blade bottom seal 190, the end seal 191, and a sheet member 194 will now be explained with reference to FIG. 1, FIGS. 12A to 12C, and FIG. 15. FIG. 12A is a perspective view for explaining the developing blade bottom seal 190, the end seal 191, and the sheet member 194 assembled to the developing frame body 151. FIG. 12B is a perspective view for explaining the developing blade unit 156 assembled to the assembly illustrated in FIG. 12A. FIG. 12C is a perspective view for explaining the developing roller 103 assembled to the assembly illustrated in FIG. 12B.

As illustrated in FIG. 1, the developing frame body 151 has the inclined surface 182 inclined with respect to the direction in which the first support portion 172a of the blade support member 156a extends. The developing frame body 151 has attachment surfaces 186a that extend in the first direction D1 on the respective ends in the longitudinal direction Y, and to which the ends of the first support portion 172a in the longitudinal direction Y are attached. The inclined surface 182 is positioned on one of the two ends of the developing frame body 151, on the inner sides of the attachment surfaces 186a in the longitudinal direction Y. The inclined surface 182 is inclined in such a manner that, in a view along a direction orthogonal to the normal line of the attachment surfaces 186a where the first support portion 172a is attached, the distance between the developing frame body 151 and the developing blade bottom seal 190, in the direction of the normal line, becomes shorter as the inclined surface 182 extends nearer to the end seal 191.

As illustrated in FIG. 12B, the developing frame body 151 has a substantially rectangular opening portion DO through which the development space communicates with the outside, and the developing roller 103 is disposed in a manner closing the opening portion DO, as illustrated in FIG. 12C. Along the perimeter of the substantially rectangular opening portion DO, the developing blade unit 156 (the developing blade bottom seal 190), the end seal 191, and the sheet member 194 are disposed continuously in a manner surrounding the opening portion DO in a ring-like shape, as illustrated in FIG. 12B. These members defines, on the outer circumferential surface of the developing roller 103, a region exposed to (facing) the developing chamber 152 in the developing frame body 151, and a region exposed to the outside of the developing frame body 151. In other words, as illustrated in FIG. 12B, the opening portion DO surrounded by the developing blade unit 156, the end seal 191, and the sheet member 194 correspond to the region, in the outer circumferential surface of the developing roller 103, facing the developing chamber 152. The developing blade unit 156 (the blade member 156b), the end seal 191, and the sheet member 194 are in close contact with the outer circumferential surface of the developing roller 103, in the manner surrounding the exposed region.

As illustrated in FIG. 12A, the developing blade bottom seal 190 and the sheet member 194 are disposed on the perimeter corresponding the two respective parallel long sides, among the four sides of the perimeter of the rectangular opening portion DO of the developing frame body 151 where the developing roller 103 is disposed, in the longitudinal direction. The sheet member 194 is disposed, among these long sides, on the upstream perimeter in the rotating direction of the developing roller 103, and the developing blade bottom seal 190 is disposed on the downstream perimeter. The developing blade unit 156 is disposed in a manner overlapping the developing blade bottom seal 190 (FIG. 12B).

The developing blade bottom seal 190 includes a double-sided tape and an elastic foam member, for example, and is bonded to the developing frame body 151 with the double-sided tape. The sheet member 194 is an elastic resin sheet, for example, and is bonded to the developing frame body 151 with a double-sided tape, not illustrated. The sheet member 194 is disposed across the entire range of the developing frame body 151 in the longitudinal direction, on the downstream side of the developing blade unit 156 in the rotating direction of the developing roller 103. The leading edge of the sheet member 194 in the short-hand direction, on the side of the developing roller 103, is a free end, and a part of this free end comes into contact with the entire circumferential surface of the developing roller 103, in the longitudinal direction.

Along the perimeter corresponding to the short-hand sides of the rectangular opening portion DO on the developing frame body 151, the short-hand sides being in parallel with each other in the rotating direction of the developing roller 103, the end seals 191 are disposed, respectively, symmetrically in the longitudinal direction. The end seals 191 are provided as a pair in a manner extending along the rotating direction of the developing roller 103, so as to connect the longitudinal ends of the developing blade unit 156 and the sheet member 194. The end seals 191 that are end sealing members (second sealing members) come into sliding contact with the outer circumferential surface of the developing roller 103 on the respective ends in the longitudinal direction of the developing frame body 151 (in the direction of the rotation axis of the developing roller 103).

Each of the end seals 191 includes a fiber layer formed of resin fibers and an elastic foam layer that are bonded to each other with an adhesive layer, for example, and an adhesive layer such as a double-sided tape for bonding the end seal 191 to the developing frame body 151 is disposed under the elastic foam layer. The end seals 191 are disposed on the respective ends in the longitudinal direction of the developing roller 103, with the fiber layer bent in a manner coming into contact with the circumferential surface of the developing roller 103.

As illustrated in FIG. 12B, the developing blade unit 156 is disposed on top of the developing blade bottom seal 190. The developing blade unit 156 includes the blade support member 156a that is a support, and the blade member 156b that is a slider. The blade support member 156a is disposed in a manner extending along the longitudinal direction of the developing frame body 151, and has respective ends fixed to the developing frame body 151 with the screws 174. In other words, the developing blade bottom seal 190 is interposed between an area between the respective ends of the blade support member 156a fixed with the screws 174, and the developing frame body 151, and seals the gap between the blade support member 156a and the developing frame body 151. In other words, the developing blade bottom seal 190 is disposed along the longitudinal direction of the developing frame body 151, along the perimeter corresponding to the sides of the opening portion DO on the developing frame body 151, the sides being ones extending along the longitudinal direction of the developing frame body 151, as a longitudinal sealing member (first sealing member). The blade member 156b has a downstream end fixed to the blade support member 156a, being downstream in the rotating direction of the developing roller 103, and has an upstream end in sliding contact, along the longitudinal direction, with the circumferential surface of the developing roller 103.

At this time, the recessed portion 181 of the developing frame body 151 and the blade member 156b are disposed in a manner at least partially overlapping each other, in a view along a direction orthogonal to the longitudinal direction of the developing blade unit 156. In other words, the recessed portion 181 of the developing frame body 151 at least partially overlaps with one end of the blade member 156b in the longitudinal direction.

In the configuration after assembling, as illustrated in FIG. 12B, the developing frame body 151 opens to the outer space, via the recessed portion 181, in a direction perpendicular to the second support portion 172b of the blade support member 156a. As illustrated in FIG. 12C, the developing roller 103 is installed in a manner closing the substantially rectangular opening portion DO formed on the developing frame body 151, and comes into sliding contact with the sheet member 194, the end seal 191, and the blade member 156b at the time when the developing roller 103 is rotated.

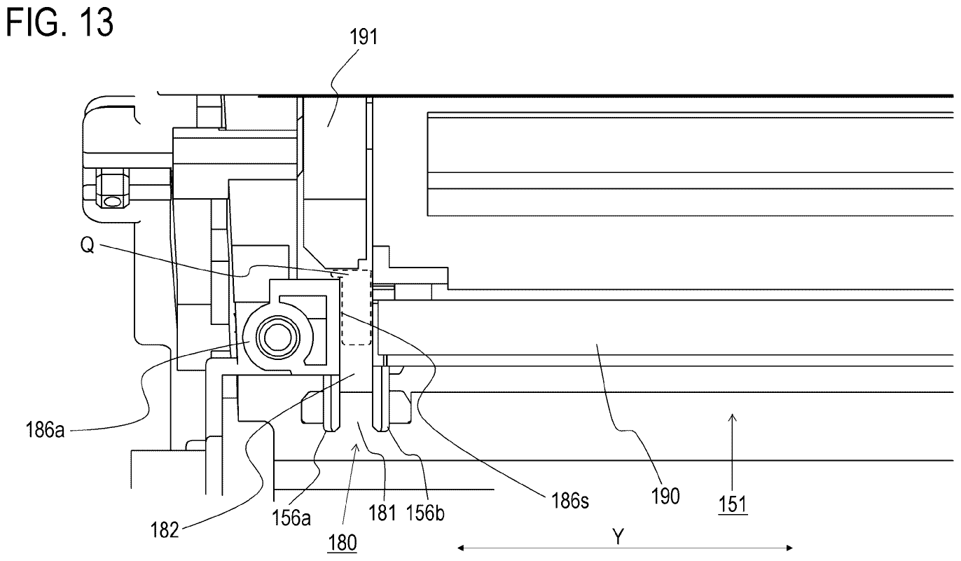

The space constituted by the developing frame body 151, the developing blade unit 156, the developing blade bottom seal 190, and the end seals 191 will now be explained in detail, with reference to FIG. 13. FIG. 13 is a perspective view for explaining the configuration with the sealing members, the sheet member 194, the developing blade unit 156, and the developing roller 103 assembled to the developing frame body 151 (with the developing blade unit 156 and the screw 174 omitted for explanation).

As illustrated in FIG. 13, in this embodiment, the space Q is constituted by the developing frame body 151, the developing blade unit 156, the developing blade bottom seal 190, and the end seals 191. Because the space Q communicates with the opening portion DO of the developing frame body 151 and to the outside of the developing frame body 151, with this configuration, the toner inside the developing frame body 151 may leak outside of the developing frame body 151 through the space Q.

As a method for preventing the leakage of the toner in this embodiment, a toner sealing member 193 is injected into the space Q. The recessed portion 181 delineating the opening for injecting the toner sealing member 193 is disposed in a manner at least partially overlapping with the end seal 191, in a view along the direction orthogonal to the longitudinal direction Y.

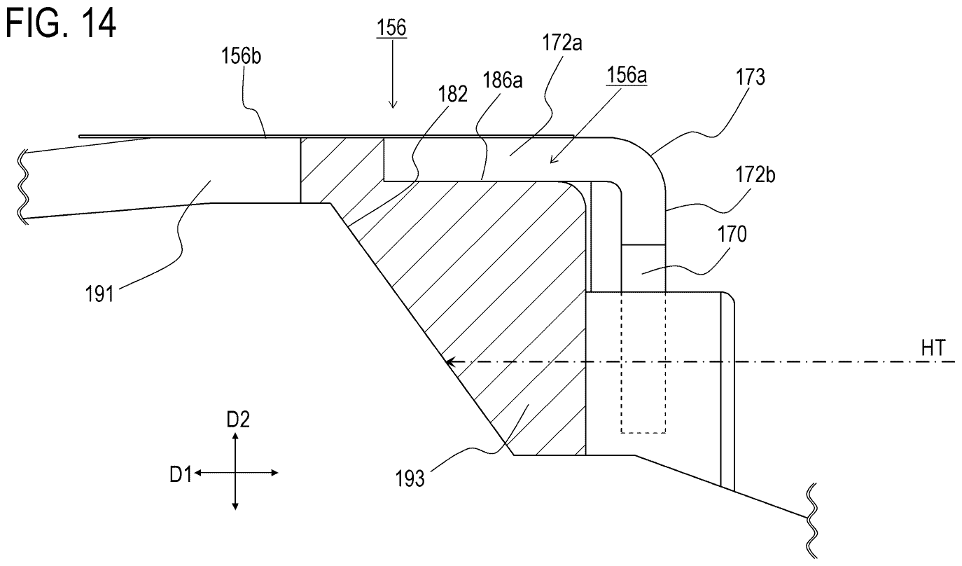

A method for injecting the toner sealing member 193 will now be explained with reference to FIGS. 14 and 15. FIG. 14 is a sectional view of the same cross section as that illustrated in FIG. 1, but after the toner sealing member 193 is injected. FIG. 15 is a perspective view from the same direction as that FIG. 13, after the toner sealing member 193 is injected (with the developing blade unit 156 and the screw 174 omitted).

In the configuration illustrated in FIG. 14, the toner sealing member 193 is injected using a toner sealant injector not illustrated, substantially along an injection trajectory HT. The injected toner sealing member 193 is poured into the space Q through the cutout portion 170 of the blade support member 156a and the recessed portion 181 of the developing frame body 151. By sealing the space Q air-tightly with the toner sealing member 193, as illustrated in FIG. 15, the leakage of the toner to the outside of the developing frame body 151 is prevented.

As illustrated in FIG. 14, by allowing the toner sealing member 193 having been injected substantially along the injection trajectory HT to land on the inclined surface 182, and to flow along the inclination of the inclined surface 182 toward the end seal 191, it is possible to seal the path communicating the space Q and inside of the developing frame body 151 air-tightly.

In the configuration described above, it is preferable to ensure a gap having a size of at least 5 mm between the first protruding portion 180a and the second protruding portion 180b of the developing frame body 151, to facilitate injection of the toner sealant 193.

As the toner sealing member 193 according to the embodiment, it is possible to use a hot-melt resin made from a mixture of a thermoplastic rubber or a tackifier resin, and having a characteristic of becoming liquified by being heated, and becoming cured as an elastic solid by being cooled.

As described above, according to the embodiment, by an engagement the developing blade positioning portion 180 provided to the developing frame body 151 and the cutout portion 170 provided to the blade support member 156a, the developing blade unit 156 can be accurately positioned with respect to the developing frame body 151. The cutout portion 170 has a function for positioning the developing blade unit 156 with respect to the developing frame body 151, and a function for defining the space for injecting the toner sealing member 193, as a single configuration. With the developing blade positioning portion 180 fitted in the cutout portion 170, it is possible to ensure the rigidity of the developing blade unit 156 and to achieve a reduction in the longitudinal width.

For example, in the configuration disclosed in Japanese Patent Application Laid-open No. 2022-130369, a first cutout portion that is a longitudinal positioning portion for the developing blade unit 156 and a second cutout portion of the blade support member 156a that is the opening for injecting the toner sealing member 192 are provided separately. Compared with such a configuration in which the blade support member 156a is provided with a plurality of cutout portions, this embodiment makes it possible to position the developing blade unit 156 with respect to the developing frame body 151 as well as to ensure the space for injecting the toner sealing member 193, only with the cutout portion 170 that is provided to a single point. Therefore, according to this embodiment, it is possible to avoid a reduction in the rigidity of the developing blade unit 156, resulting from providing a plurality of cutout portions to the blade support member 156a, as well as to reduce the longitudinal width of developing blade unit 156.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-057735, filed on Mar. 29, 2024, which is hereby incorporated by reference herein in its entirety.

What is claimed is:

1. A developing apparatus comprising:
a frame body having a storage chamber for storing developer, and provided with an opening portion communicating with the storage chamber;
a developing roller disposed in a manner facing the opening portion, and supported rotatably by the frame body about a rotation axis;
a regulating unit regulating a layer thickness of the developer borne on an outer circumferential surface of the developing roller, with the regulating unit including a sliding member coming into sliding contact with the outer circumferential surface of the developing roller, and a support member for supporting the sliding member; and
a sealing member sealing a space between the frame body and the regulating unit, in a first end of the frame body in a direction of the rotation axis,
wherein the support member has a recessed portion that is recessed in a direction intersecting with the rotation axis, and that is provided to an end of the support member on a side the same as the first end of the frame body, in the direction of the rotation axis, the recessed portion being constituted by surfaces including a first side surface and a second side surface that extend in the direction intersecting,
wherein the frame body has protruding portions that includes a first protruding portion and a second protruding portion that are aligned with respect to each other between the first side surface and the second side surface, with a gap between the first protruding portion and the second protruding portion in the direction of the rotation axis, and protruding in a direction intersecting with the rotation axis,
wherein, by an engagement between the protruding portion and the recessed portion, the support member is positioned with respect to the frame body in the direction of the rotation axis, and
wherein the space communicates with outside of the frame body via the gap.

2. The developing apparatus according to claim 1, wherein the space is sealed with the sealing member, through the gap.

3. The developing apparatus according to claim 1, wherein the sealing member is visible from outside of the frame body, through the gap.

4. The developing apparatus according to claim 1,
wherein the support member includes:
a first support portion fixed to the frame body and extending in a first direction intersecting with the rotation axis; and
a second support portion extending in a second direction intersecting with both of the rotation axis and the first direction from one end of the first support portion in the first direction;
wherein the sliding member is attached to the first support portion in a manner protruding in the first direction from another end of the first support portion in the first direction,
wherein the recessed portion is provided, in a manner recessed in the second direction, to an end of the second support portion on an opposite side of an end continuous with the first support portion, and
wherein the first protruding portion and the second protruding portion protrude further outwards than the second support portion, with respect to the frame body, in the first direction.

5. The developing apparatus according to claim 4, wherein the first protruding portion and the second protruding portion are provided in a manner extending in the first direction, from a side outer than the second support portion with respect to the frame body, to a side nearer to the space than the second support portion.

6. The developing apparatus according to claim 4, wherein, in a view from a direction orthogonal to the rotation axis, the gap at least partially overlaps with an end of the sliding member, the end being an end on a side the same as the first end of the frame body in the direction of the rotation axis.

7. The developing apparatus according to claim 4,
wherein a surface of the frame body includes an inclined surface facing the first support portion, the surface being a surface constituting the space, and the inclined surface extending in a direction inclined with respect to both of the first direction and the second direction in a manner gradually approaching the first support portion, as the inclined surface extends in a direction in which the sliding member protrudes from the first support portion, and
wherein the gap is provided in a manner continuous to the inclined surface.

8. The developing apparatus according to claim 7,
wherein the frame body is provided with attachment surfaces extending in the first direction on respective ends of the frame body in the direction of the rotation axis, the attachment surfaces being surfaces to which respective ends of the first support portion in the direction of the rotation axis are attached, respectively, and
wherein the inclined surface is positioned on an inner side of the attachment surface of one of the respective ends in the direction of the rotation axis.

9. The developing apparatus according to claim 1, further comprising:
a first sealing member provided along the direction of the rotation axis so as to provide sealing to a region between a downstream region of a perimeter of the opening portion in a rotating direction of the developing roller, and the support member of the regulating unit; and
a second sealing member provided along the rotating direction, to a region outside of the opening portion in the direction of the rotation axis, and coming into sliding contact with an end of the outer circumferential surface of the developing roller in the direction of the rotation axis, and
wherein the gap at least partially overlaps with the second sealing member in a view in a direction orthogonal to the rotation axis.

10. The developing apparatus according to claim 9,
wherein the space is constituted by the frame body, the regulating unit, the first sealing member, and the second sealing member, on respective ends of the frame body in the direction of the rotation axis, in such a manner that the storage chamber communicates with outside of the frame body via the opening portion.

11. A cartridge attachable to and detachable from an apparatus main body of an image forming apparatus, the cartridge comprising:
an image bearing member; and
the developing apparatus according to claim 1.
